(19) United States
(12) Patent Application Publication
(10) Pub. No.: US 2025/0135660 A1
(43) Pub. Date: May 1, 2025

(54) SUCTION GRIPPER HEAD, ELEMENTARY MODULE AND ASSOCIATED FRAME

(71) Applicant: PIAB AKTIEBOLAG, Danderyd (SE)

(72) Inventor: Laurent JOULIN, Issy les Moulineaux (FR)

(21) Appl. No.: 18/681,805

(22) PCT Filed: Aug. 5, 2022
(86) PCT No.: PCT/EP2022/072153

§ 371 Date: Feb. 6, 2024

(30) Foreign Application Priority Data
Aug. 6, 2021 (FR) FR2108558

(51) Int. Cl. B25J 15/06

(52) U.S. Cl. CPC B25J 15/0683

(57) ABSTRACT

A suction gripper head includes at least two elementary gripper modules. Each module includes a frame having at least one side provided with at least one opening, the two modules are joined together such that a first side provided with at least one opening of the frame of a first module faces a second side provided with at least one opening of the frame of a second module so that gas may pass between the two modules facilitated by the openings on the first side and on the second side, wherein the openings on the first side and on the second side also face each other.

The invention relates to a suction gripper head comprising at least two elementary modules.

The invention also relates to an elementary module of such a head.

The invention also relates to a frame of such a module.

### BACKGROUND OF THE INVENTION

Devices for gripping and transporting products such as boards, boxes, bags, material plates comprising a suction gripper head are known.

In known devices, gripper heads are connected to a suction device, such as a turbine or an electric pump, or also a compressed air vacuum generator, such as a Venturi effect vacuum generator.

Moreover, so-called “surface gripper” gripper heads and so-called “specific gripper” gripper heads are known. Different from specific gripper heads which each only Different comprise one single suction cell, the surface gripper heads each comprise a plurality of suction cells.

According to the product to be removed, the needs of a user can vary, in particular, in terms of dimensions of the gripper head.

It is always possible for the user to arrange, side-by-side, several gripper heads to create a gripper device of greater dimensions.

Such a solution remains relatively difficult to implement, due to the suction being done through the top of each gripper head: all suction heads must thus be connected to the suction device. Furthermore, such a solution remains very limited, as the number of gripper heads thus juxtaposed can only be reduced or increased.

### AIM OF THE INVENTION

An aim of the invention is to propose a solution making it possible to propose a suction gripper device which is more easily versatile.

### SUMMARY OF THE INVENTION

In view of achieving this aim, a suction gripper head is proposed, comprising at least two elementary gripper modules, each module comprising a frame comprising at least one side provided with at least one opening, the two modules being assembled to each other, such that a first side provided with at least one opening of the frame of a first module faces a second side provided with at least one opening of the frame of a second module, so that gas may pass between the two modules, facilitated by the openings of the first side and of the second side, the openings of the first side and of the second side also facing each other.

In this way, by assembling several modules, the user can easily manufacture a gripper head of greater dimensions than those of each module, gripper head thus having specific dimensions adapted to the needs of the user.

The invention thus makes it possible for the user to be able to themselves design their own gripper head from elementary modules, without necessarily going through the supplier.

Advantageously, the assembly of the modules can subsequently be reconfigured with a different placement of the modules to each other and/or with a different blocking of the openings of the modules, generating a new gas circulation path to thus be adjusted to a new application targeted by the user.

The invention thus makes it possible for the user to be able t to easily reconfigure the gripper head without necessarily going through the supplier.

Moreover, thanks to the openings, gas, and for example air, can easily circulate from one module to another.

It is thus possible to configure the different modules, by blocking one or more openings, to define one or more gas circulation paths (independent or not from each other) through the different modules: at least one of the paths can enable a sequential activation of the associated modules, a parallel activation, a simultaneous or quasi-simultaneous activation, etc.

Moreover, if so desired, it is possible to associate to the gripper head, one single suction device, which is connected to only one of the modules of the gripper head, the gas circulation within the gripper head indeed occurring in the thickness of the gripper head, from one module to another.

Furthermore, the invention makes it possible to be able to produce, in series, the elementary modules which reduces their manufacturing costs.

The invention thus makes it possible for a non-expert user, to be able to assemble the modules like a puzzle. The invention thus makes it possible to create a gas circulation path, forming depression inside the gripper head, without requiring an entire cascade of external connections to said head.

Optionally, the two modules are identical.

Optionally, all the modules of the head are identical to each other, except for the presence of at least one suction orifice provided in one of them.

Optionally, the module equipped with a suction orifice forms a corner of the gripper head.

Optionally, the first side is contiguous with the second side.

Optionally, the gripper head comprises at least one blocker, shaped to temporarily block at least one of the openings.

Optionally, the head comprises at least one connecting interface, shaped to be arranged at at least one of the openings.

Optionally, at least one of the modules comprises at least two openings.

Optionally, a first of the two openings is arranged on a first side of the module and a second of the two openings is arranged on a second side of the module adjacent to the first side, or opposite the first side.

Naturally, the module can optionally comprise openings which are additional to the two mentioned above.

Optionally, the modules are arranged, such that the gripper head has a cross-section, at the frame, having an external contour of a shape different from a square or a rectangle.

Optionally, the modules are shaped, so as to each have at least one large side and one small side, the modules being able to be contiguous through their small sides, their large sides or one, through its small side and the other, through its large side.

Optionally, the modules are arranged, so as to define, via their openings, at least two gas circulation paths in the gripper head, which are independent from each other.

Optionally, the modules are arranged, so as to define, via their openings, at least one gas circulation path in the gripper head, which comprises at least one baffle.

Optionally, the gas suction path is shaped in a coil.

Optionally, the gripper head comprises means for fixing at least the two modules to each other, fixing means comprising at least one fixing system at least partially carried by at least one of the modules.

Optionally, the fixing means thus comprise at least one hinge system.

Optionally, the gripper head comprises means for fixing at least the two modules to each other, fixing means comprising at least one fixing system, which is born at least partially on at least one of the modules.

Optionally, the gripper head comprises means for fixing at least the two modules to each other, said fixing means comprising at least one fixing system arranged at two openings facing said two modules.

The fixing system can thus be configured to block the circulation of a gas between the two modules or, on the contrary, to let the gas circulate between the two modules.

Optionally, the gripper head comprises at least one lower plate, extending under at least two modules, by being fixed to each of said two modules.

Optionally, the gripper head comprises at least one base arranged under at least one of the modules and intended to be in contact with a product to be raised.

Optionally, the base is arranged under at least two modules.

Optionally, the base is made of foam.

Optionally, the base extends under all the modules of the gripper head.

Optionally, the modules are fixed to each other, such that the upper faces of their frames extend in one same plane.

Optionally, the gripper head comprises means for fixing at least the two modules to each other, fixing means comprising at least one fixing system carried at least partially by at least one of the modules, the fixing system being shaped to extend mounted on the upper faces of at least the two frames.

Optionally, at least one of the modules comprises at least one layer which is additional to its frame, said layer being arranged at least partially in the frame or being arranged fully inside the frame, the additional layer being a base, a valve compartment or a plate.

Optionally, the head comprises at least one foam base arranged under at least one of the modules and intended to be in contact with a product to be raised.

The invention also relates to an elementary module of such a gripper head.

The invention also relates to a frame of such a module.

For the present application, the terms “horizontal”, “vertical”, “upper”, “lower”, etc. must be understood according to the working position of the gripper head when it is above a product to be raised. By “cross-section”, this means a section along a horizontal cutting plane (when the suction head is in its working position).

Other features and advantages of the invention will emerge upon reading the description below of particular, non-limiting embodiments of the invention.

### BRIEF DESCRIPTION OF THE DRAWINGS

The invention will be best understood in the light of the description below, in reference to the accompanying figures, among which:

FIG. 1 is a partial, explosed view of a gripper head according to a first embodiment of the invention;

FIG. 2a schematically illustrates a first variant of a fixing of modules of the gripper head represented in FIG. 1;

FIG. 2b schematically illustrates a second variant of a fixing of modules of the gripper head represented in FIG. 1;

FIG. 2c schematically illustrates a third variant of a fixing of modules of the gripper head represented in FIG. 1;

FIG. 2d schematically illustrates a fourth variant of a fixing of modules of the gripper head represented in FIG. 1;

FIG. 2e schematically illustrates a fifth variant of a fixing of modules of the gripper head represented in FIG. 1;

FIG. 2f schematically illustrates a sixth variant of a fixing of modules of the gripper head represented in FIG. 1;

FIG. 3 is a partial bottom view of a gripper head according to a second embodiment of the invention;

FIG. 4 is a schematic cross-sectional view of a gripper head according to a third embodiment of the invention;

FIG. 5 is a schematic cross-sectional view of a gripper head according to a fourth embodiment of the invention;

FIG. 6 is a schematic cross-sectional view of a gripper head according to a fifth embodiment of the invention;

FIG. 7 is a bottom view of a gripper head according to a variant of the second embodiment of the invention.

### DETAILED DESCRIPTION OF EMBODIMENTS OF THE INVENTION

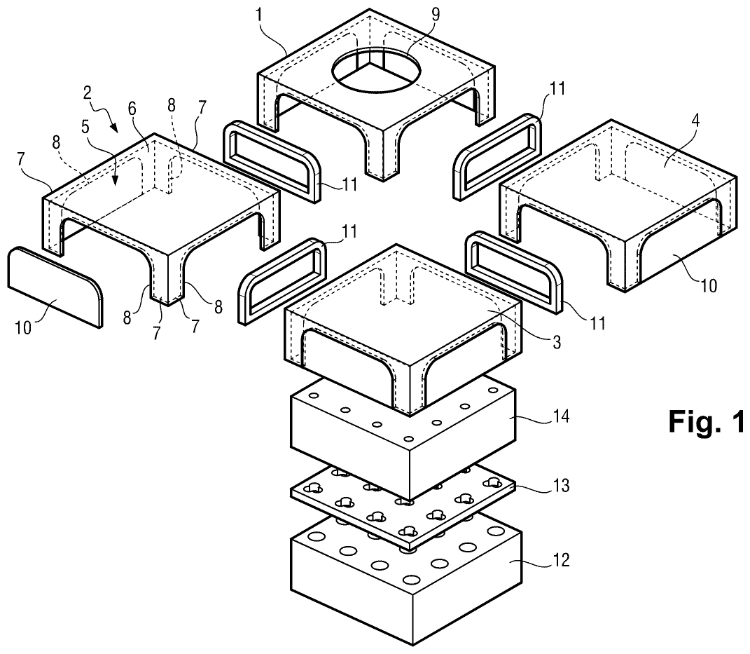

In reference to FIG. 1, the gripper head according to a first embodiment of the invention comprises, in this case, a suction device (not represented, in this case). The suction device is optionally a vacuum generator such as a compressed air vacuum generator. For example, the vacuum generator is a Venturi effect vacuum generator.

Moreover, the gripper head comprises at least two elementary gripper modules. In the present case, the head only comprises four elementary gripper modules 1, 2, 3, 4. Each module comprises a frame.

The description below of one of the frames 5 applies, in this case, to the three other frames.

Typically, the frame 5 comprises an upper face 6 shaped in a quadrilateral. For example, the upper face 6 is shaped in a square.

The frame 5 moreover comprises lateral sides 7. The frame comprises, in this case, only four sides 7. Each side 7 extends from one of the edges of the upper face 6 orthogonally to said upper face 6. In this way, two successive sides 7 extend orthogonally to each other.

At least one of the side 7 is provided with at least one opening 8. For example, at least two successive sides 7 are each provided with at least one opening 8. In the present case, each side 7 is provided with at least one opening 8. For example, each side 7 is provided with one single opening 8. The different sides 7 are, in this case, identical to each other.

Each openings 8 passes through the associated side. Each opening 8 is, in this case, provided so as to only open onto the lower side of the associated side 7 (and not on the other sides of said side): each side 7 is thus opened on its lower side. In a variant, each opening 8 is provided to not open onto any side of the associated side 7.

Each opening 8 is, in this case, centred (on the width) of the associated side 7.

Each opening 8 is, for example, shaped to have a rounded-edge rectangular cross-section.

All the openings 8 are identical to each other. Optionally, the frame 5 is made of one piece. Thus, the upper face 6 and the four sides 7 are integrally formed. Optionally, the frame 5 is made of plastic material or of metal material.

For example, the frame 5 is manufactured by injection or also by folding.

Moreover, to ensure the circulation of a gas (such as air or another gas in the case where the gripper head would be placed in an environment with a particular atmosphere) through the different modules, at least one of the frames 5 is equipped with a suction orifice 9. Preferably, only some of the frames 5 are equipped with a suction orifice 9. For example, one single frame 5 is equipped with a suction orifice 9.

For this frame 5, the suction orifice 9 is provided in its upper face 6, so as to pass through it. Said suction orifice 9 is, for example, provided at the centre of the upper face 6.

Consequently, in this first embodiment, three of the four frames 5 are identical to each other. The fourth frame 5 is moreover identical to the three other frames 5, apart from the fact that it is equipped with at least one suction orifice 9.

It is noted that in the present case, the lower face of each frame 5 (opposite the upper face 6 of the frame in question) is opened towards the outside of the module.

On another aspect, the different modules 1, 2, 3, 4 are fixed to each other.

Preferably, the different modules 1, 2, 3, 4 are fixed to each other, such that their different upper faces 6 extend in one same plane. Said plane is preferably horizontal.

In the first embodiment, the four modules 1, 2, 3, 4 are arranged such that each module is fixed to two other modules. The four modules thus jointly form a rectangular parallelepiped. Moreover, due to the square cross-section of each frame 5, the gripper head itself has, at the different frames 5, a square external contour cross-section.

Preferably, the modules 1, 2, 3, 4 are fixed to each other, such that their frames 5 are contiguous in pairs.

For a pair of two modules, said two modules are further fixed to each other, such that a first side 7 provided with at least one opening 8 of a first of the two modules faces a second side 7 provided with at least one opening 8 of the second of the two modules, the two openings 8 facing each other in alignment. The two openings 8 being of the same dimensions, they jointly form a uniform cross-section channel over its length, when the two modules are contiguous to each other.

In this way, for each module, a first of its openings 8 extends into the alignment of an opening of a first other module and a second of its openings 8 extends into the alignment of a second other module, the two other openings 8 being oriented towards the outside of the gripper head.

To fix the different modules 1, 2, 3, 4 to each other, the gripper head comprises fixing means.

Preferably, for a fixing of at least two modules to each other, the fixing means comprise at least one fixing system arranged to be accessible through the inside of at least one of the associated frames 5.

This makes it possible to dismount a fixing between at least two modules, without having to necessarily dismount all the modules from the gripper head.

Optionally, for a fixing of at least two modules to each other, the fixing means comprise at least one fixing system arranged in the top parts of the frames 5 of the two associated modules.

For example, the fixing means comprise, at each junction of two modules, at least one male member/female member pair (forming fixing system) able to engage together to fix said two modules to each other and optionally, at least two male member/female member pairs (forming two fixing systems) able to engage together to fix said two modules to each other. For example, at least one of the male members is a nut and at least one of the female members is a screw. Optionally, at least one of the male members is made of one part with one of the two modules of the junction in question (i.e. integrally formed with the frame of said module).

In view of the gripper head which has just been described, it is therefore understood that air can freely circulate through all the openings 8 and the suction orifice 9.

Consequently, in order to be able to define an air circulation path in the gripper head, the gripper head preferably comprises at least one blocker 10 (only one of which is referenced, in this case), completely blocking an opening 8 to block the passage of air through said opening 8.

At least one of the blockers 10 is presented, for example, in the form of a platelet.

At least one of the blockers 10 is removably mounted on at least one of the openings 8, for example, by interlocking.

The blockers 10 are all identical, in this case.

At the junction of two modules, the following can be done:
Blocking the two openings 8 facing each other with one same blocker 10, or
Blocking a first of the two openings 8 with a first blocker 10 and a second of the two openings 8 with a second blocker 10 (the two blockers 10 thus being able to optionally be fixed to each other).

In the first embodiment, each opening 8 rotated towards the outside of the gripper head is closed by a blocker 10. Air cannot thus laterally enter or exit from the gripper head. Air can only thus enter or exit from the gripper head through the suction orifice 9 or the low part of the gripper head.

However, each opening 8 rotated towards another opening 8 remains free of any blocker 10, enabling air to circulate freely between the different modules.

Preferably, the gripper head comprises at least one connecting interface 11, shaped to be arranged at at least one of the openings 8.

At least one of the connecting interfaces 11 is presented, for example, in the form of a pierced platelet.

At least one of the connecting interfaces 11 is removably mounted on at least one of the openings 8, for example, by interlocking.

The connecting interfaces 11 are all identical, in this case.

At the junction of two modules, the following can be done:
Arranging one same connecting interface 11 on the two openings 8 facing each other, or
Arranging a first connecting interface 11 at a first of the two openings 8 and arranging a second connecting interface 11 at the second of the two openings 8 (the two connecting interfaces 11 thus being able to optionally be fixed to each other).

For example, each pair of aligned openings 8 is, in this case, provided with one single connecting interface 11. Consequently, the four pairs of aligned openings 8 each comprise one single connecting interface 11. Said interfaces 11 favour the passage of air from one module to another. The blockers 10 and the connecting interfaces 11 thus make it possible to create a quite specific air circulation path inside the gripper head.

It is noted that the gripper head has been proven as particularly modular, since it is sufficient to simply modify the blockers 10 and/or the connecting interfaces 11 to shape another air circulation path in the gripper head, and this, without even affecting the relative position between the different modules 1, 2, 3, 4.

Preferably, the gripper head comprises sealing means at the junction between each pair of modules 1, 2, 3, 4, such as, for example, at least one seal.

For example, at least one of the openings 8 is provided with a seal on its perimeter and/or at least one of the blockers 10 is provided with a seal on its perimeter and/or at least one of the connecting interfaces 11 is equipped with a seal on its outer perimeter. Both at least one of the two openings 8 of a junction provided with a seal and at least one of the associated blockers 10 (or at least one of the connecting interfaces 11) also provided with a seal can thus be had.

Alternatively, or complementarily to the presence of sealing means at at least one of the openings 8 and/or at least one of the blockers 10 and/or at least one of the connecting interfaces 11, sealing means can also be present at at least one of the sides 7 of at least one of the frames 5. For example, at least one of the sides 7 of at least one of the frames 5 is provided with a seal on its external perimeter.

Advantageously, the fixing means contribute to the sealing of the different junctions by compressing the different seals during the fixing of the different seals to each other.

Optionally, at least one of the modules 1, 2, 3, 4 comprises at least one layer which is additional to its frame 5.

In the present case, the four modules 1, 2, 3, 4 comprise at least one additional layer, in addition to their frame 5.

Preferably, the four modules 1, 2, 3, 4 comprise precisely the same additional layers. The four modules 1, 2, 3, 4 are therefore identical to each other, apart from at the suction orifice 9 of one of the modules.

The description below of the additional layers of one of the modules 3 is therefore also valid for the other modules.

The module 3 comprises, in this case, a first additional layer in the form of a base 12.

The base 12 is, in this case, secured to the frame 5 of the module 3, the lower face of the base 12 being that intended to come directly into contact with the product to be held.

The base 12 is preferably made of foam.

The base 12 is made of one part, in this case.

The base 12 can be:
fully housed in the frame 5 (such that the base 12 does not exceed the open lower face of said frame 5; preferably thus the lower face of the base 12 extends into one same plane as the lower faces of the sides 7 of the frame 5),
partially housed in the associated frame 5 (such that the base 12 only partially exceeds the open lower face of said frame 5),
fully housed outside of the frame 5.

In cases a) or b), the base 12 preferably extends between the four sides 7, so as to close the lower part of the frame 5. In case c), the base 12 preferably extends so as to cover the entire open lower face of the frame 5.

Preferably, the module 3 has a surface gripper. The base 12 thus comprises a plurality of cells regularly distributed in the base 12.

This makes it possible to be able to apply the gripper head with a greater variability of products to be handled.

Each cell is, in this case, formed of a hole extending rectilinearly so as to open at a first end at the upper face of the base 12, and at the second end at the lower face of the base 12.

The module 3 comprises, in this case, a second additional layer in the form of a lower plate 13.

Optionally, the base 12 is not directly fixed to the frame 5, but is fixed to said frame 5 by way of said plate 13. Said plate 13 is thus directly fixed to the base 12 by its lower face. Alternatively, said plate 13 has dimensions less than those of the upper face of the base 12 and/or of the open lower face of the frame 5. In this case, the base 12 is also directly fixed to the frame on zones not covered by the plate 13. The overlapping of the base 12 over both the plate 13 and the frame 5 makes it possible to improve the sealing of the assembly.

The plate 13 is, for example, made of plastic material or made of metal material (for example, aluminium).

Naturally, the plate 13 is pierced with holes (only one part of which is referenced, in this case), each hole extending preferably rectilinearly in the extension of one of the cells of the base 12.

The geometry of the holes is different, according to the type of gripper targeted at the module 3.

For example, at least one of the holes can be calibrated and/or of a diameter less than or greater than that of the facing cell and/or contain a valve and/or contain means for holding a valve in place, etc.

The plate 13 is arranged fully outside of the frame 5 or is arranged at least partially in the frame 5 or is arranged fully inside the frame 5.

Optionally, the module 3 comprises a third additional layer in the form of a valve compartment 14.

Optionally, the plate 13 is not directly fixed to the frame 5, but is fixed to said frame 5 by way of said valve compartment 14. The valve compartment 14 is, for example, directly fixed to the frame 5 by its upper face and directly fixed to the plate 13 by its lower face.

The valve compartment 14 is arranged fully outside of the frame 5 or is arranged at least partially in the frame 5 or is arranged fully inside the frame 5.

In a manner known per se, the valve compartment 14 comprises passages (only one part of which is referenced, in this case), wherein valves are arranged. Preferably, each passage extends rectilinearly into the valve compartment 14 in the extension of an orifice of the plate 13.

It is possible to arrange the valves of the valve compartment 14 according to at least one specific air circulation path. For example, said path comprises at least one baffle. For example, said path is shaped, so as to form a coil enabling a cascade closing of said valves.

When working, the suctioning is performed via the suction device through the suction orifice 9 in a first module 1, then is propagated horizontally inside the different modules, thanks to the pairs of openings 8. Moreover, at each module 1, 2, 3, 4, the suctioning continues vertically successively through the valve compartment 14, the plate 13 and the base 12.

Thus, each module 1, 2, 3, 4 comprises an individual vacuum distribution chamber (formed, in this case, by the internal side of the upper face of the frame 5, the upper face of the valve compartment 14 and the corresponding side portions 7), the individual vacuum distribution chambers moreover being connected at least partially to each other through the openings 8, thus defining at least one general vacuum distribution chamber of the gripper head.

In the first embodiment, the different modules 1, 2, 3, 4 are activated simultaneously or almost simultaneously, since the suctioning from the module 1 provided with the suction orifice 9 can be propagated in all directions, thanks to the pairs of openings 8.

In a variant, the circulation path can be modified to enable, for example, a sequential activation of the different modules 1, 2, 3, 4 (that is a cascade activation of the different modules 1, 2, 3, 4). For example, instead of a connecting interface 11 arranged at the junction between the module 1 equipped with the suction orifice 9 and one of the two adjacent modules (called below, fourth module 4), the gripper head can comprise a blocker 10. Thus, the suctioning will be propagated in one module after the other: first the module 1 equipped with the suction orifice, then the second adjacent module 2 with the associated pair of openings 8, still letting air circulate, then the third module 3 adjacent to the second module 2 and finally, the fourth module 4.

The great modularity of the gripper head described is once again noted.

Complementarily and/or alternatively, at least two independent air circulation paths can be created in the gripper head, for example, by only enabling the circulation of air between two modules at the same time (and by creating another suction orifice on another of the modules).

The great modularity of the gripped head described is once again noted.

Complementarily and/or alternatively, at least two suction zones with distinct properties can be created in the head, for example:
by having at least one of the modules, the plate 13 of which comprises a first type of hole and at least one of the modules, the plate 13 of which comprises a second type of hole,
by having at least one of the modules provided with a valve compartment 14 and at least one other of the modules without a valve compartment (or a different valve compartment 14), etc.

On another aspect, the different frames 5 are advantageously all identical to each other (apart from the suction orifice 9): it is thus possible to easily produce and at a lesser cost, the different frames 5 (particularly that the suction orifice 9 can be provided once the frame is already formed).

In addition, it has proven to be easy for a user to create their own gripper head, in particular due to the different frames 5 all being identical (up to the suction orifice 9).

Naturally, the first embodiment which has just been described is not limiting, and numerous variants can be considered.

For example, the fixing means can be different from what has been described.

For example, a fixing system can be shaped to fix more than two modules together. For example, the fixing system can be shaped to fix together at least three modules, and for example, all the modules of a row.

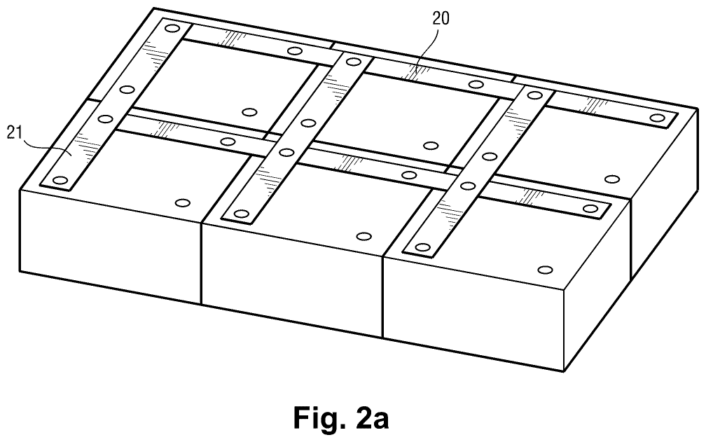

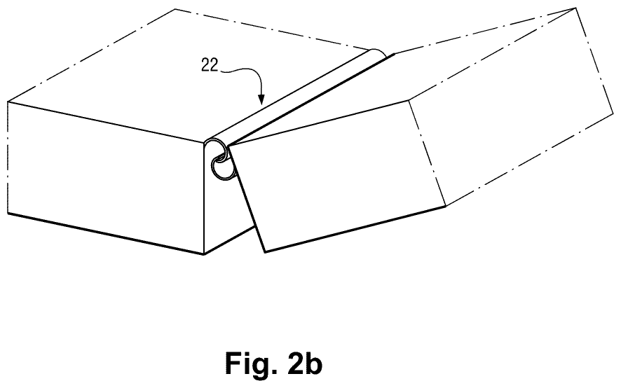

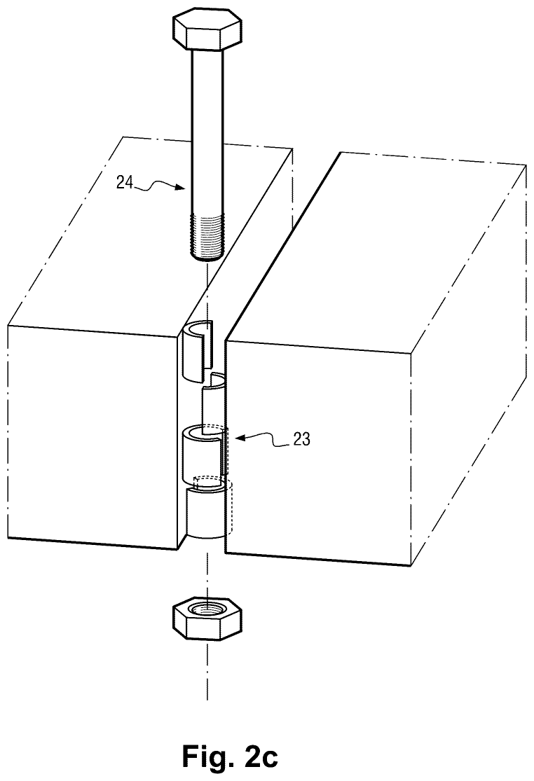

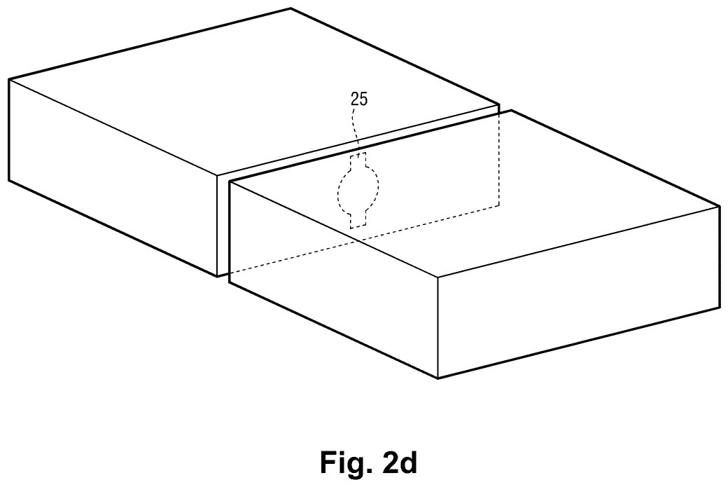

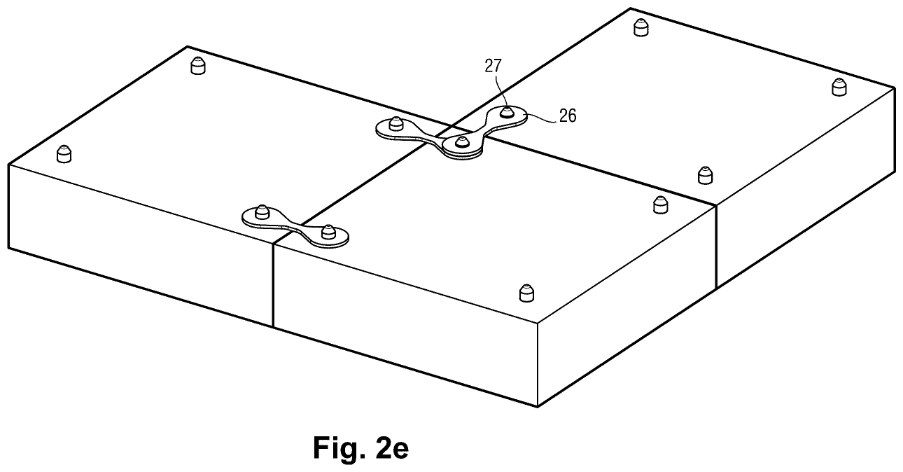

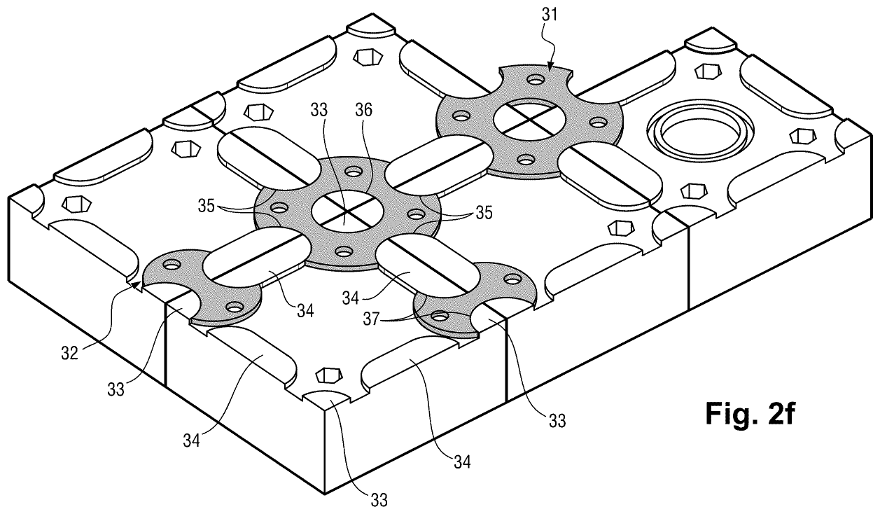

In reference to FIG. 2a, the fixing system is of the female member/male member type, the female member being a bar 20 (only one being referenced, in this case) extending over the upper faces of the frames of a first row of modules, and engaging:
with screws (forming male member), and/or
with pins (forming male member) arranged on each of the modules of the first row, and/or
with at least one other bar 21 (forming male member). only one being referenced, in this case—extending over the upper faces of the frames of a second row of modules (which extends, for example, orthogonally to the first row).

The bar 20 extending outside of the modules, it has proven to be easy to detach or attach the different modules of a row together.

Instead of extending over the upper faces of a row of modules, the bar 20 can extend through the frames of the row of modules.

Instead of extending over the upper faces of a row of modules, the bar 20 can extend over a series of adjacent sides of the row of modules.

Naturally, at least one bar 20 can also be resorted to, to only attach two modules together, like in the first embodiment.

Although, in this case, the fixing system described can be shaped to fix all the modules of a row, the fixing system can also be shaped to fix together several modules to each other (that they form a row or not), and for example, all the modules of the gripper head. For example, the fixing system can comprise an upper plate, extending above the upper face of different modules, each module thus being fixed to said upper plate.

It is also possible that at one same junction between two modules, the fixing means comprise more than one fixing system for the fixing of the two modules to each other (different fixing system or not in pairs).

For example, two bars such as described above can thus be had (instead of only one) to secure at least two modules to each other.

For example, in reference to FIG. 2b, the fixing means comprise, at one same junction between two modules:
a first fixing system in the form of a hinge system 22,
a second fixing system of the male member/female member type (not represented).

For example, the hinge system 22 is arranged in the top part of the sides 7 facing the junction and the second fixing system is arranged in the bottom part of the same sides 7 (or vice versa).

In this second variant, the hinge system 22 extends horizontally. The internal and external portions of the hinge system 22 extend respectively along the upper edges of the sides 7 facing the junction.

Preferably, at least two sides 7, and preferably all the sides 7 of at least one of the modules are equipped, either with the external portion, or with the portion of a hinge system 22.

For example, two successive sides 7 are equipped with the internal portion of the hinge system 22, while the two other sides 7 are equipped with the external portion of the hinge system 22.

Preferably, all the sides 7 of all the modules 1, 2, 3, 4 are equipped, either with the external portion, or with the internal portion of a hinge system.

This makes it possible for a user to be able to easily secure the modules 1, 2, 3, 4 together.

At least one of the hinge systems 22 can be different from what has been indicated.

Thus, in reference to FIG. 2c, the fixing means comprise a hinge system 23 extending vertically.

The elements of the hinge system 23 extend respectively along the vertical edges of the sides 7 facing the junction.

Preferably, at least two sides 7, and preferably all the sides 7 of at least one of the modules are equipped with at least one of the elements of the hinge system 23.

Preferably, all the sides 7 of all the modules 1, 2, 3, 4 are equipped with at least one of the elements of the hinge system 23.

This makes it possible for a user to be able to easily secure the modules together.

For example, an element of the hinge system 23 is shaped in a hook.

For example, at an edge of a first module, the first module comprises at least one and preferably at least two hooks. Preferably, said two hooks are not arranged at the same level and/or rotated in the same way, that the two corresponding hooks arranged on an edge facing a second module. For example, over a height of the two modules, the four hooks shape a column with successively a hook of the first module, a hook of the second module, a hook of the first module and a hook of the second module.

For a given module, the two hooks can have a different shape. For example, one of the hooks can have an opening, and the other not, or one of the hooks can have a larger opening than the other module. The second fixing system 24 comprises, in this case, an axle, a screw, etc., being vertically inserted into the different hooks, engaging together at the junction in question, to result in the fixing of the assembly.

The second variant and the third variant can also be combined: thus, the hinge system 22 of the second variant can be arranged vertically like in the third variant; the hinge system 22 of the second variant can be formed of a greater number of elements (and not only one internal portion and one external portion) like in the third variant.

Alternatively, the elements can be shaped such that at the junction between two modules, two elements are sufficient by engaging together to form the hinge system 23 and at a junction between four modules, four elements are sufficient by engaging together to form the hinge system 23.

For example, an element of the hinge system 23 is shaped in a hook. In order to enable the formation of a hinge system 23 at the junction between four modules, for each of the modules 1, 2, 3, 4, at each of the vertical edges of a given module, the hook associated with the edge is not arranged at the same level and/or rotated and/or opened in the same way as the other hooks of the other edges of the same module.

The fixing means can also assist with the openings 8 to fix at least two modules to each other.

For example, in reference to FIG. 2d, at least one of the sides 7 of a first of the frames 5 and at least one of the sides 7 of a second of the frames 5 can each comprise an opening 8 having at least one notch. For example, for each of the two frames 5, the opening 8 has a circular cross-section with two rectangular-shaped radially opposite extensions, each extension thus forming a notch.

The two notched openings 8 are identical, in this case.

Preferably, for each frame 5, the notched opening 8 in onto any of the edges of the question does not open associated side 7. Preferably, for each frame 5, the notched opening 8 in question is centred on the associated side 7.

It is noted that for a given side 7, the notched opening 8 can replace the opening 8 described in reference to FIG. 1, or be additional to it.

A fixing system, being presented in the form of a stopper 25 of shape adapted to the notched openings 8, is thus arranged through the two notched openings 8 extending into the alignment from each other, thus making it possible to fix the two modules to each other.

If the stopper 25 is solid, it prevents air from circulating through the pair of notched openings 8 and also plays a blocker role, in addition to its fixing system role.

If the stopper 25 is hollow, it enables air to circulate through the pair of notched openings 8 and also plays a role of a connecting interface 11, in addition to its fixing system role.

The stopper 25 can have a cross-section of shape identical to that of the cross-section of the notched orifices (at least externally), or can have a central section, the cross-section of which is less than that of the notched orifices, central section extended on either side by end sections, each having a cross-section of shape identical to that of the cross-section of the notched orifices 8 (at least externally).

In this way, the stopper 25 can be introduced into the pair of notched openings 8, then a rotation of the stopper is performed to block the stopper 25 in the position in the notched openings 8.

In reference to FIG. 2e, instead of a screw-nut fixing system, the fixing system can be of the fastener-pin tab type.

The fastener tab can be shaped in an hourglass 26 (only one being referenced, in this case), surrounding a pin 27 (only one being referenced, in this case) respectively present on each of the two modules of a given junction. For example, the pins 27 can be arranged at the lower faces of the frames 5 of said modules or of the sides 7 defining the junction or upper faces of said modules.

This fastener-pin tab fastening system can, for example, be cumulated to the bar fixing system of FIG. 2a, or to the hinge system illustrated in FIG. 2b.

As has already been indicated, at least one of the fixing systems can be arranged on at least one of the sides 7 or thus above or below the frames 5.

Thus, according to a sixth variant illustrated in FIG. 2f, the fixing system is shaped to extend mounted on the upper faces 6 of at least two adjacent frames 5.

A first fixing system 31 is, in this case, shaped to be able to link four modules to each other, and a second fixing system 32 is, in this case, shaped to be able to link two modules to each other.

For example, the first fixing system 31, like the second fixing system 32 are shaped in a platelet.

Moreover, raised parts are formed on the upper face 6 of at least one of the frames 5, and preferably of all the frames 5 of the gripper head.

These raised parts are, in this case, identical from one module to another. The description below of raised parts of one of the modules, therefore also applies for the other modules.

For example, a raised part 33 is present at each corner of the upper face. Optionally, the different corner raised parts 33 are all identical, and for example, shaped in a quarter-circle. For example, an additional raised part 34 is present between each pair of two corner raised parts 33. Optionally, the different additional raised parts 34 are shaped in half of an oblong shape.

Correspondingly, the fixing systems 31, 32 are shaped to enable them to be interlocked between the different raised parts, in order to attach the modules together.

For example, the first fixing system 31 is shaped, so as to have, over its external contour, four recesses 35, as well as a central orifice 36 piercing through it. The first fixing system 31 is therefore, in this case, shaped in a cross pierced in its centre.

Thus, when the first fixing system 31 is arranged at the junction between four modules, the four corner raised parts 33 (a corner raised part 33 belonging respectively to one of the modules), jointly forming a disc, are housed in the central orifice 36 and the four pairs of additional raised parts 34 (two additional raised parts 34 per module), jointly forming an oblong shape are each housed in one of the recesses 35.

For example, the second fixing system 32 is shaped so as to have two recesses 37 over its external contour. The first fixing system 32 is therefore, in this case, shaped in an hourglass.

Thus, when the second fixing system 32 is arranged at the junction between two modules, the pair of corner raised parts 33 (a corner raised part 33 belonging respectively to one of the modules), jointly forming a semi-disc is housed in one of the recesses 37, and the pair of additional raised parts 34 (one additional raised part 34 per module), jointly forming an oblong shape is housed in the other of the recesses 37.

Preferably, each fixing system 31, 32 is further associated with at least one other fixing system, such as, for example, a male member/female member fixing system, and for example, a screw-nut system. For example, the first fixing system 31 is attached to each of the four modules associated by a screw-nut assembly and the second fixing system 32 is attached to each of the two modules associated by a screw-nut assembly. To this end, the first fixing system 31 is pierced with four orifices (at each of the branches of the cross) and the second fixing system 32 is pierced with two orifices (at the two portions of the hourglass).

Naturally, it is possible to combine different fixing systems within one same gripper head.

Naturally, the different variants described, as well as the first embodiment can be mixed. For example, two modules can be fixed to each other via a hinge system, as that described in the third variant, but arranged horizontally at the junction between two modules, like in the second variant.

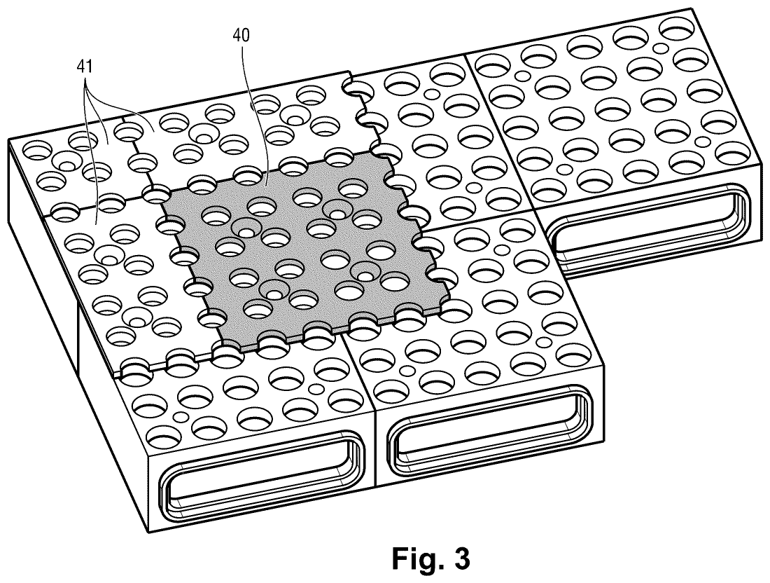

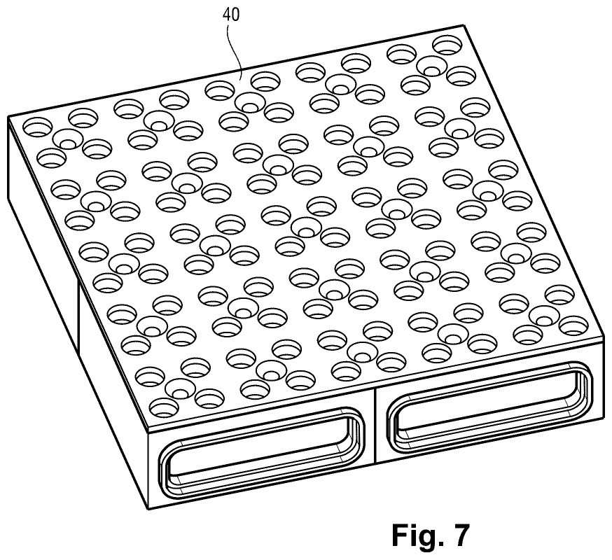

A second embodiment will now be described in reference to FIGS. 3 and 7.

While in the first embodiment, each module comprised its own lower plate 13 centred under the module in question, in the second embodiment, the modules do not comprise a lower plate which are specific to them.

However, the gripper head itself comprises at least one lower plate 40, which is associated with at least two different modules.

The plate 40 is, for example, made of plastic material or made of metal material (for example, aluminium).

Naturally, the plate 40 is pierced with holes (only one part of which is referenced, in this case), each hole extending preferably rectilinearly into the extension of one of the cells of the base.

The geometry of the holes is different according to the type of gripper targeted at the module.

For example, at least one of the holes can be calibrated and/or of a smaller or greater diameter than that of the facing cell, and/or contain a valve, and/or contain means for holding a valve in place, etc.

According to a first variant, which is illustrated in FIG. 7, the gripper head comprises one single plate 40, which is associated with all the modules of the gripper head. For example, said plate 40 extends under the different modules. For example, said plate 40 has a cross-section of dimensions identical to those of the surface delimited by all the lower faces of the frames 5 of the gripper head (the gripper head thus comprises one single plate 40 covering the entire lower surface of the different modules). Said plate 40 is fixed to at least one of the associated modules, and preferably to all the associated modules (either directly, or by way of valve compartment(s)).

According to a second variant, not illustrated in this case, the gripper head comprises several main plates 40, each main plate 40 being associated with at least two modules of the gripper head by extending under these two modules. For example, each main plate 40 is thus associated with four modules of the gripper head, by extending under these four modules. For example, each main plate 40 has a cross-section of dimensions identical to those of the surface delimited by the lower face of one of the frames 5 of the gripper head.

Each main plate 40 is fixed to at least one of the associated modules and preferably to all the associated modules (either directly, or by way of valve compartment(s)).

According to a third variant, illustrated in FIG. 3, the gripper head comprises at least one main plate 40, each main plate 40 being associated with at least two modules of the gripper head, by extending under these two modules. For example, each main plate 40 is thus associated with four modules of the gripper head, by extending under these four modules. For example, each main plate 40 has a cross-section of dimensions identical to those of the surface delimited by the lower face of one of the frames 5 of the gripper head.

Each main plate 40 is fixed to at least one of the associated modules and preferably to all the associated modules (either directly, or by way of valve compartment(s)).

Furthermore, in this third variant, the gripper head can also comprise secondary plates 41. Preferably, the gripper head comprises secondary plates 41, in order to cover the portions of the lower face of the gripper head (delimited by all the lower faces of the frames 5 of the gripper head), which would not be covered by the main plates 40. For example, the secondary plates 41 and the main plates 40 jointly have a cross-section of dimensions identical to those of the surface delimited by all the lower faces of the frames 5 of the gripper head. Each secondary fixing plate 41 is fixed to at least one of the associated modules and preferably to all the associated modules (either directly, or by way of valve compartment(s)).

In the three variants, each plate 40 advantageously makes it possible to secure together at least two modules, each plate thus itself playing the role of a fixing system.

Optionally, the gripper head can comprise at least one fixing system which is additional to the plate(s) 40, such as a fixing system described above. Preferably, only the plate(s) 40 will be used for fixing in the lower part of the gripper head of at least two modules to each other, the additional fixing system(s) being, for example, arranged preferably in the top part of the gripper head.

For example, the gripper head can comprise additional fixing systems, such as those illustrated in FIG. 2f to reinforce the fixing of the modules to each other in the top part of the gripper head.

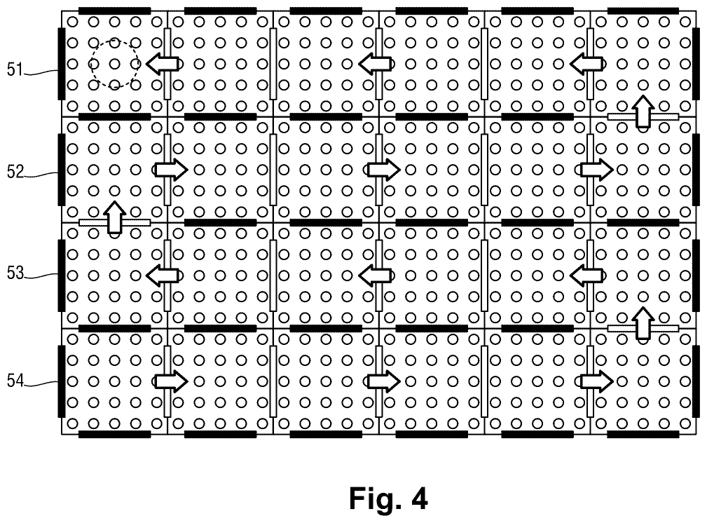

In reference to FIG. 4, a third embodiment of the invention will now be described.

This third embodiment is identical to the first embodiment, with it being different that the gripper head comprises a greater number of modules.

For example, the head of the third embodiment comprises twenty modules like those described in reference to the first embodiment.

The different modules are fixed to each other, such that the gripper head has, at the different frames 5, a cross-section of rectangular external contour. For example, the modules are arranged so as to form four rows 51, 52, 53, 54, each of five modules.

In this third embodiment, only one of the modules is provided with a suction orifice. Preferably, said module forms one of the corners of the gripper head.

Optionally, the gripper head is arranged so as to shape one single air circulation path through the different modules enabling a sequential activation of said modules.

For example, the air circulation path comprises at least one baffle.

For example, the air circulation path is shaped in a coil.

To this end, in this case, blockers and connecting interfaces assist with shaping this air circulation path through the different modules.

For the third embodiment, as indicated by the arrows in FIG. 4, the suctioning is performed via the suction orifice on the top of the first module (at the top-left), which is thus activated: the only side of said module enabling air to circulate with another module is its right side, such that only the right module is then activated (i.e. the suctioning is propagated by this right module), and so on, up to the module on the bottom-left.

Naturally, the number of modules can be different from what has been indicated for the first embodiment, and the third embodiment, and for example be two (like in the fourth embodiment, which will now be described), or eight (like in the fifth embodiment, which will subsequently be described).

On another aspect, at least one of the modules can be different from what has been indicated up to now, and for example, have a more complex frame.

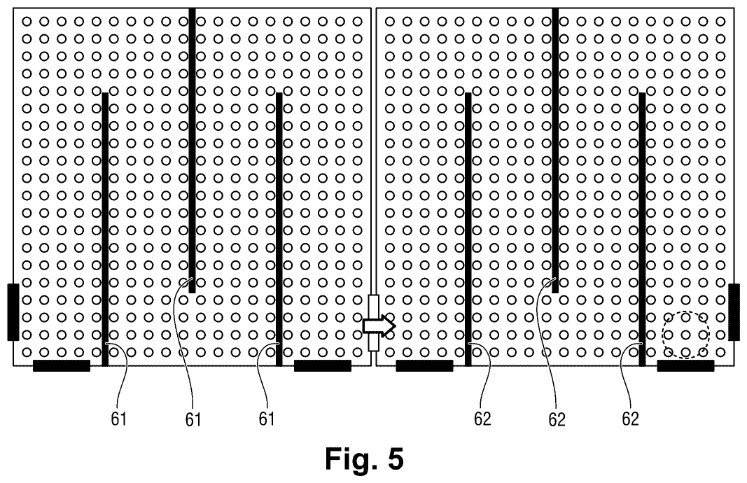

For example, as can be seen in FIG. 5, the frame of at least one of the modules integrates internal walls 61, directly forming inside the associated module, at least one elementary air circulation path.

For example, the frame is arranged, so as to shape one single air circulation path, which comprises at least one baffle.

For example, said air circulation path is shaped in a coil.

In this fourth embodiment, the gripper head comprises two modules, the frames of which each have internal walls 61, 62 forming a coil in each of the frames. The gripper head is moreover arranged to enable a connection of the two coils to each other.

In this way, the gripper head defines a general air circulation path, which is shaped in a coil (and which is formed by the succession of the two elementary air circulation paths of each of the modules).

On another aspect, at least one of the sides of at least one of the modules can comprise a greater number of openings, than what has been indicated.

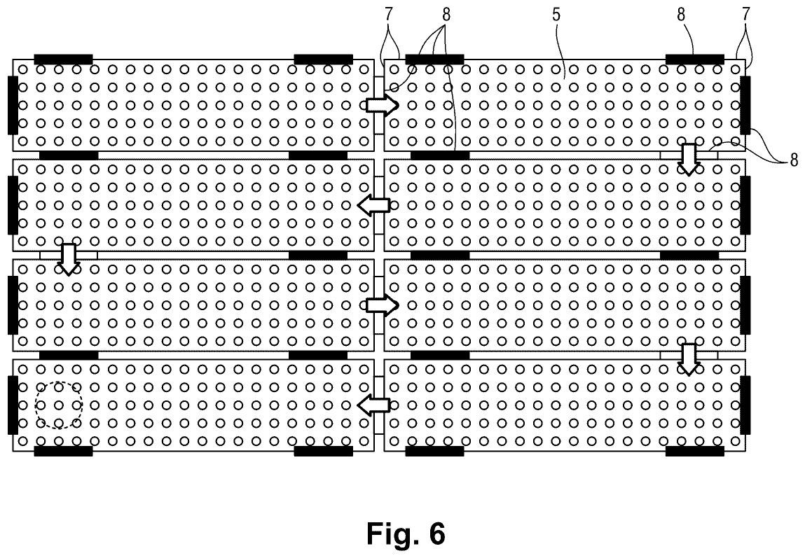

Thus, in reference to FIG. 6, at least one of the sides of at least one of the modules can comprise two different openings.

In this fifth embodiment, (the references being applied to only one of the modules in the figure to facilitate its reading), the upper faces of the frames 5 are moreover rectangular and no longer square (being understood that the number of openings per side 7 is independent of the shape of the associated upper face 6).

Moreover, for each frame 5, the sides 7 forming long sides of the frame 5 each have two openings 8 and the sides 7 forming short sides of the frame 5, one single opening 8. Each frame 5 thus has six openings 8, with two openings 8 for each long side.

Preferably, the openings 8 of the sides 7 forming small sides are each centred over the length of the associated side 7 and the openings 8 of the sides 7 forming large sides are arranged respectively at each of the longitudinal ends of the associated side 7. In this way, each frame 5 has third openings 8 at each of its ends.

In the fifth embodiment, the gripper head is arranged to define an air circulation path having at least one baffle. For example, the air circulation path is shaped in a coil.

It will be understood, whatever the embodiment or the variant in question, the gripper head easily makes it possible to achieve different air circulation path configuration through the different modules (enabling a sequential activation of modules or a parallel activation of modules or an activation in all the directions of modules), and/or to create at least two air circulation paths through the modules independent from each other, and/or to create at least two suction zones with distinct properties.

By parallel activation, this means the parallel activation of modules of at least two rows of different modules.

Advantageously, the assembly of modules can be easily dismounted and reconfigured with a different placement of the modules and/or of the blockers 10 and/or of the connecting interfaces 11 to be adjusted to a new application targeted by the user.

Naturally, the invention is not limited to the embodiments described, and variants can be provided without moving away from the scope of the invention such as defined by the claims.

The suction device can directly form part of the gripper head. Alternatively, the suction device can be remote from the gripper head (it will thus not form part of the gripper head). This will enable to reduce the mass of the gripper head, while preserving the gripping capacity. The suction device can be a Venturi effect vacuum generator, or any other type of vacuum generator, such as for example, a turbine or a pump.

The gripper head can comprise a greater number of types of elementary modules than what has been indicated (in the present case, two types, one with and one without the suction orifice), and for example, three types of elementary modules.

The gripper head can comprise more than one suction orifice. For example, at least two modules can each comprise at least one suction orifice and/or at least one module can solely comprise at least two suction orifices.

At least one suction orifice can be provided in one of the sides of at least one of the modules. At least one suction orifice can be formed directly by one of the openings of at least one of the modules.

At least one of the suction orifices cannot be arranged at the centre of the side or of the upper face of the associated module. For example, at least one of the suction orifices can be placed closer to one of the edges of the upper face (or of the side) than the other edges. For at least one of the modules, the lower plate can be fixed to the frame without being partially or totally arranged inside the frame and/or the base. For at least one of the modules, a lower plate can be avoided.

At least one lower plate cannot comprise any calibrated hole and thus be a simple element for rigidifying the frame and/or the gripper head. Complementarily or in replacement of the lower plate, the gripper head can incorporate another fixing member of at least one base to at least one frame, such as a valve compartment. Also, such a fixing member can be dispensed with, at least one base thus being directly fixed to at least one of the frames.

Although, in this case, each module comprises its own base, at least one of the modules cannot comprise any base which is specific to it (and this, that the gripper head moreover comprises one or more bases, or that the head does not comprise any bases).

For example, the gripper head can comprise one single base extending under the different modules of said head, or extending at least under two modules of said head.

Although, in this case, each module comprises its own valve compartment, at least one of the modules cannot comprise any valve compartment which is specific to it (and this, that the gripper head moreover comprises one or more other valve compartments, or does not comprise any valve compartments).

Although, in this case, each module comprises its own lower plate, at least one of the modules cannot comprise any lower plate which is specific to it (and this, that the head moreover comprises one or more other lower plates, or does not comprise any fixing plate).

Moreover, although, in this case, each gripper module is with surface gripper, at least one of the modules can be with specific gripper. In any case, the gripper head will be a surface gripper head.

Although, in this case, each base is made of one single part, at least one base can be composed of several foam blocks secured to each other, for example, by bonding, by screw-type fixing elements, etc. The foam blocks can be assembled to each other vertically, horizontally or in other directions.

Although, in this case, the modules are arranged, such that the gripper head has a cross-section of square or rectangular external contour (at the frames), or can naturally arranged the modules in another way, such that the gripper head is of the most suitable shape possible for the product to be raised. The modules can thus not be arranged, so as to form identical columns and rows.

The frame of at least one of the modules can take a shape, other than that indicated: the frame can thus have a rectangular, square, diamond, triangular, regular or non-regular polygonal cross-section, even a cross-section having at least one curved portion.

Consequently, at least one of the frames can comprise a different number of sides than what has been described, for example, one single side or at least two sides, or also at least three sides, at least five sides, at least six sides, etc.

At least one side of the frame cannot comprise openings.

If the frame comprises at least two sides, each provided with at least one opening, said sides can be sides extending facing each other, one in succession of the other, or can be two other sides of the frame. In the case where the frame only comprises four sides, the two sides can thus be successive sides, or opposite sides of the frame.

At least one opening can be of such large dimensions, that the corresponding side will thus only be delimited by this opening (i.e. will not comprise walls around the opening).

At least one of the sides of the frame can comprise at least two openings. In the case of a rectangular cross-sectional frame, at least one of the sides forming a small side can comprise at least two openings and/or at least one of the sides forming a large side can comprise at least two openings. The openings can thus be distributed equidistantly along the associated side and/or centred facing the associated side and/or arranged at the ends of the associated side.

Although, in this case, the different openings within one same module are identical, at least two openings within one same module can be different from each other. Although, in this case, the different openings between two different modules are identical, at least one first opening of a first module and a second opening of a second module can be different from each other.

The cross-section of at least one opening can be different from what has been indicated. Thus, a triangular, circular, elliptical, etc. cross-sectional opening can be had.

Two facing openings can be shaped to engage with each other: for example, one can comprise overflowing rims, able to be inserted into the hollow rims from the other.

Whatever the shape of at least one of the sides, at least one opening can be provided in said side in a non-centred manner on said side (whether the height and/or the width of said side is considered).

Although, in this case, lower faces of the different frames are open, at least one of the frames can comprise a closed lower face (and provided with at least one suction opening).

The gripper head cannot comprise any connecting interface, the air circulating thus simply from one module to the other via the openings.

The gripper head, in its simplest version, cannot comprise a blocker either, the head thus only comprising two modules, each of the modules only comprising one single opening rotated towards the opening of the other module.

At least one blocker can be directly carried by one of the modules and not born on it. For example, the blocker can be a flap movably mounted on one of the sides of the module in question between a position, wherein it covers the opening and a position, wherein it enables the passage of air through the opening. Although, in this case, the blockers are shaped to completely block the associated opening(s), at least one blocker can be arranged to only partially block at least one of the associated openings.

At least one connecting interface can be directly carried by one of the modules and not born on it. For example, the connecting interface can be a flap, movably mounted on one of the sides of said module between a position, wherein it extends into the opening of said side and a position, wherein it extends outside of the opening of said side. For example, the connecting interface can be permanently mounted in the associated opening, at least one blocker thus being shaped to block the connecting interface (and thus the opening), in order to block the passage of air through the connecting interface (and therefore the opening).

Although, in this case, each frame is made of one single part, at least one of the frames can be formed of at least two parts, rigidly fixed to each other. For example, the frame can be composed:
of one single part forming both the upper face, the sides and the lower face, or
of a first part forming both the upper face and the sides of a second part fixed to the first, forming the lower face of the frame,
of a first part forming the upper face, of a second part forming the sides and of a third part forming the lower face of the frame, the three parts being fixed together,
of a first part forming the upper part of the frame and of a second part forming the lower part, the fixing of the two parts to each other thus shaping the sides,
of a first part forming both the lower face and the sides, and of a second part fixed to the first, forming the upper face,
etc.

Naturally, the different embodiments described can be mixed together. Thus, the different fixing options of the modules to each other (main variant in FIG. 1 and ancillary variants in FIGS. 2a to 2f) can be applied to the different embodiments described. The number of modules of the fifth embodiment can be applied to the fourth embodiment, and vice versa. The fixing via the plate, like in the third embodiment, can be applied to the fourth embodiment or to the fifth embodiment. One same gripper head can comprise both modules with square cross-sectional frames, like in the first embodiment, and modules with rectangular cross-sectional frames, like in the fourth embodiment or the fifth embodiment, etc.

Fixing means other than those indicated will moreover be considered. The fixing means can thus comprise a dovetail fixing system, a connecting rod fixing system, an insert fixing system extending through one or more modules, an upper and/or lower and/or lateral and/or capsule fixing system, a snap-fitting fixing system (for example, by snap-fitting of sides to each other), etc. For example, the insert can extend through at least two modules (i.e. inside said modules), and for example, through a row of modules for their fixing to each other. For example, at least one bar (such as illustrated in FIG. 2a) can be arranged, so as to extend inside at least two modules (and not outside, as what has been indicated in reference to FIG. 2a), to fix them together, and for example, so as to extend inside a series of modules to fix them together. Said bar can thus be shaped in a tie rod, making it possible to clamp at least two modules together. For example, the fixing system can comprise at least one lateral capsule extending between at least one first side of a first module and a second side of a second module, the second side being juxtaposed to the first side, each side being fixed to said capsule, such that this can fix the two modules together. The capsule can be shaped to fix more than two modules together, and for example, a row of modules together. The capsule can be shaped in the form of a plate or can be shaped differently. For example, the capsule can be shaped, so as to guide a gas flow between at least one opening of the first side and an opening of the second side (juxtaposed to the first side). The capsule can thus serve directly as a connecting interface. A capsule can thus be had, which fixes an entire row of modules, the capsule moreover being shaped to ensure the circulation of the gas from one module to another (for example, using an internal wall).

It is noted that a fixing system can also play another role, like for example, that of a connecting interface, that of a blocker or also of a rigidifier (for example, in the case of a plate, of a capsule, or an insert, of a bar, etc.).

Whatever the fixing system(s) considered, at least one system can carry a sealing means (seal type) to contribute to the sealing of the gripper head.

In the case where the lower plate will extend under several modules, said plate can be formed from a larger plate, provided with cutouts, thus making it possible for the user to easily create a plate with the dimensions which suit them.

At least one of the modules cannot comprise any valve compartments and/or lower plate and/or base. The gripper head can thus not integrate any valve compartment and/or any lower plate and/or any base.

Preferably (but not compulsorily), if the gripper head is a valve gripper head, the gripper head will be arranged, so as to enable a sequential activation of at least several modules.

Preferably (but not compulsorily), if the gripper head is not a valve gripper head, the gripper head will be arranged to enable an activation of the modules in all directions.

If the module comprises at least one additional layer in addition to their frame, said layer cannot be fixed to the frame, but form an integral part of the frame.

The frame and the additional layer can thus be machined together simultaneously, be moulded together simultaneously, be manufactured by additive manufacture simultaneously together, etc.

For example, if the additional layer is a valve compartment, said valve compartment can be of one single part with the frame. The frame and the valve compartment can thus be machined together simultaneously, be moulded together simultaneously, be manufactured by additive manufacture simultaneously together, etc. In this way, one single part will be formed, fulfilling both the role of valve compartment and the role of a frame.

1. A suction gripper head, comprising at least two elementary gripper modules, each module comprising a frame (5) comprising at least one side (7) provided with at least one opening (8), the two modules being assembled to each other, such that a first side provided with at least one opening of the frame of a first module faces a second side provided with at least one opening of the frame of a second module so that a gas may pass between the two modules, facilitated by the openings of the first side and of the second side, the openings of the first side and of the second side themselves facing each other.

2. The suction gripper head according to claim 1, wherein all the modules are identical to each other, except for the presence of at least one suction orifice-(9) provided in one of them.

3. The suction gripper head according to claim 1, comprising at least one blocker (10), shaped to temporarily block at least one of the openings.

4. The suction gripper head according to claim 1, comprising at least one connecting interface (11) shaped to be arranged at at least one of the openings.

5. The suction gripper head according to claim 1, wherein at least one of the modules comprises at least two openings (8).

6. The suction gripper head according to claim 5, wherein a first of the two openings-(8) is arranged on a first side of the module and a second of the two openings is arranged on a second side of the module, which is adjacent to the first side, or which is opposite the first side.

7. The suction gripper head according to claim 1, wherein the modules are arranged, such that the gripper head has a cross-section, at the frames (5), having an external contour of a shape different from a square or a rectangle.

8. The suction gripper head according to claim 1, wherein the modules are shaped, so as to each have at least one large side and one small side, the modules being able to be contiguous by their small sides, one through its small side and the other, through its large side.

9. The suction gripper head according to any one of the preceding claim 1, wherein the modules are arranged so as to define, via their openings (8), at least two gas circulation paths in the gripper head, which are independent from each other.

10. The suction gripper head according to claim 1, wherein the modules are arranged so as to define, via their openings (8), at least one gas circulation path in the gripper head, which comprises at least one baffle.

11. The suction gripper head according to claim 1, comprising at least one lower plate (13), extending under at least two modules, by being fixed to each of said two modules.

12. The suction gripper head according to claim 1, wherein the gripper head comprises at least one base (12) arranged under at least one of the modules and intended to be in contact with a product to be raised.

13. The suction gripper head according to the preceding-claim 1, wherein the base (12) is arranged under at least two modules.

14. An elementary module for a gripper head, according to claim 1.

15. A frame of an elementary module according to claim 14.
